(19) United States
(12) Patent Application Publication
(10) Pub. No.: US 2022/0361707 A1
(43) Pub. Date: Nov. 17, 2022

(54) BEVERAGE PREPARATION SYSTEMS

(71) Applicant: Koninklijke Douwe Egberts B.V., Utrecht (NL)

(72) Inventor: Nicholas Hansen, Banbury (GB)

(21) Appl. No.: 17/789,136

(22) PCT Filed: Dec. 22, 2020
(86) PCT No.: PCT/EP2020/087569

§ 371 Date: Jun. 24, 2022

(30) Foreign Application Priority Data
Dec. 24, 2019 (GB) 1919313.5

(51) Int. Cl. A47J 31/44

(52) U.S. Cl. CPC A47J 31/4489; A47J 31/4403; A47J 31/4485

(57) ABSTRACT

In a system including a beverage preparation machine and a compatible steam wand (11), the machine has a wand holder (1) for releasably mounting the wand and a source of steam. The machine includes a steam nozzle (23) engageable with the wand and mounted for movement between an operative position in which it is fluidly connected with the source of steam and a rest position in which it is fluidly isolated from the source of steam. The nozzle is biased to the rest position. When the nozzle is in its rest position it can be at least partially engaged with the wand before the wand is fully inserted in the holder. The arrangement such that the steam nozzle (23) is moved to the operative position on insertion of the wand fully into the holder.

### TECHNICAL FIELD OF THE INVENTION

The present invention relates to beverage preparation machines and systems comprising a beverage preparation machine and a steam wand. The invention further relates to methods of attaching a steam wand to a beverage preparation machine and to steam wands.

### BACKGROUND TO THE INVENTION

Beverage preparation machines, such as coffee machines, are known to be provided with frothing systems with which a milk container can be associated for warming and/or frothing a milk beverage. The increasing demand from consumers for the consumption of coffee preparations including a layer of frothed milk, such as, for example, cappuccino, macchiato, flat white and/or latte, has directed the coffee industry to focus on developing new and/or improved frothing systems.

A layer of foam improves the appeal of the beverage preparation, resulting in a better experience for consumers and a higher customer satisfaction.

In known frothing systems, heating and frothing is usually provided via a flow or jet of steam which is sent into the milk container through a steam wand (also called a froth wand), to warm and emulsify the milk beverage.

The steam wand is typically an elongate member which in use extends into a cup or other container in which the beverage is to be heated and frothed. The wand has a steam conduit through which steam is passed from an inlet end of the wand connected to a steam supply in the beverage preparation apparatus, which steam then travels to an outlet end of the wand, configured to eject the steam into the beverage.

Such a system is known for example from US-A1-2003/0131735 in which the wand includes a generally tubular external sleeve and an inner core within the external sleeve. The inner core defines the steam conduit and the wand further includes a coupling mechanism to facilitate connection of the wand to a steam supply of a beverage preparation machine. The coupling mechanism may include threads, clamps, grooves, quick connect mechanisms, or other suitable fasteners complementarily configured to connect with the steam supply and allow for de-coupling and re-coupling of the wand from the steam supply to facilitate maintenance and cleaning. The external sleeve may be removed for cleaning and repair. For example, the external sleeve may be removed after a beverage of one flavour is prepared, so as to minimize the risk of imparting an undesired flavour to a subsequently prepared beverage. In addition, several different external sleeves individually configured to accommodate specific functions may be interchangeably coupled to the wand core, thus diversifying the utility of the wand.

It is desirable from a hygienic point of view that the wand is de-coupled, cleaned and re-coupled after each use. However, in the system known from US-A1-2003/0131735, this process requires a lot of time, making it somewhat impractical, with the result that users of the system frequently refrain from cleaning the wand after it has been used, which could lead to health risks. In addition, a contaminated wand may also contaminate the inside of the beverage preparation machine, which internal contamination may be hard to remove.

To address some of the issues in the earlier system, WO2017/003289 A2 proposed a system in which the wand is disposable and in which it is easier and quicker to remove and replace the wand. The system includes a beverage preparation machine having a steam nozzle connected with a steam source and a wand holder in which a wand is removably received. The wand holder is manually movable between an operational position in which the steam nozzle is in fluid communication with a steam inlet of the wand and a non-operative position in which the wand can be inserted into or removed from the wand holder. In this arrangement, a used wand can be quickly and easily removed from the machine by moving the wand holder to the non-operative position. The used wand can be discarded and replaced by a new wand.

The provision of disposable wands enables the system to be used in a very hygienic manner, while at the same time reducing the time required to change the wand since cleaning of a used wand can be dispensed with. Whilst this is an improvement on the system disclosed in US-A1-2003/0131735, there is an ongoing need to develop arrangements for mounting and de-mounting a wand to a beverage preparation machine which are simpler and more intuitive from an end user's perspective.

A particular issue with replaceable wands is the need to reliably and safely connect the wand to the steam supply in the beverage machine. Some solutions have proposed the use of a steam nozzle in the beverage preparation machine which is moved into engagement with the wand once the wand has been correctly mounted to the machine and subsequently disengaged from the wand once the frothing process has been completed to allow the wand to be removed. Whilst these arrangements work effectively, they are complex and expensive requiring an actuator arrangement and control system to move the steam nozzle into and out of engagement with the wand. Such arrangements also require a valve to regulate the flow of steam through the steam nozzle. Typically, an electronic valve is used, which also adds to the cost and complexity.

It would be therefore advantageous to provide a solution which mimics the behaviour of the known frothing systems, but enables an easy and intuitive insertion of a wand into a beverage preparation machine.

It would be furthermore advantageous to provide a solution which would provide an easy de-coupling of a wand from a beverage preparation machine.

Finally, it would be advantageous to provide a solution which allows for effective coupling of the wand with the steam source which is less complex and cheaper than the known arrangements.

It is therefore an aim of embodiments of the invention to satisfy the highly-felt need of an easy-to-use foaming solution to overcome or mitigate at least one problem of the prior art whether disclosed herein or not.

### SUMMARY OF THE INVENTION

Aspects of the invention relate to a beverage preparation system, to a beverage preparation machine, a steam wand and to a method of mounting a steam wand in a beverage preparation machine.

In accordance with a first aspect of the invention, there is provided a beverage preparation system comprising a beverage preparation machine and a compatible steam wand, the beverage preparation machine comprising a steam wand connection arrangement including a steam wand holder for releasably mounting the compatible steam wand to the beverage preparation machine and a source of steam, the connection arrangement including a connector body and a steam nozzle movably mounted in the connector body, the steam nozzle having a steam inlet port, a steam outlet port, and a steam passage connecting the steam inlet port with the steam outlet port, the steam outlet port being located at an outlet end of the steam nozzle which is engageable with a steam nozzle coupling of the compatible steam wand, the steam nozzle being movable between an operative position in which the steam inlet port is fluidly connected with the source of steam and a rest position in which the steam inlet port is fluidly isolated from the source of steam, the steam nozzle being biased to the rest position, the arrangement configured such in the rest position of the steam nozzle its outlet end is positioned for engagement with the steam nozzle coupling of the compatible steam wand before the wand is fully inserted in the holder and such that the steam nozzle is movable from the rest position to the operative position against the bias force on insertion of the compatible steam wand fully into the holder with the outlet end of the steam nozzle engaged with the steam nozzle coupling of the compatible steam wand.

In an embodiment, the connector body defines a bore in which the steam nozzle is slidably located and a steam inlet duct connected with the source of steam which opens into the bore, the inlet port of the steam nozzle being fluidly coupled with the steam inlet duct when the steam nozzle is in the operative position and fluidly isolated from the steam inlet duct when the steam nozzle is in its rest position. The connector body may also define a venting duct which opens into the nozzle bore, and the arrangement may be configured such that when the steam nozzle is in its rest position, a fluid path is defined between the steam inlet duct and the venting duct. The steam nozzle may be profiled to define said fluid path between the steam inlet duct and the steam venting duct when it is in its rest position.

The steam nozzle coupling of the compatible steam wand may comprises a bore in which the outlet end of the steam nozzle is insertable. The steam nozzle may have an abutment configured to engage the compatible steam wand to limit insertion of the outlet end into the bore.

In an embodiment, the connector arrangement includes an over pressure valve configured to open to allow steam to vent from the steam passage in the steam nozzle in the event that the pressure in the steam passage exceeds a given value. The steam nozzle may define an over pressure port fluidly connected with the steam passage, and the over pressure valve may comprises a valve member biased to close the port, the valve member being movable against the bias force to open the over pressure port in the event that the pressure inside the steam passage exceeds said given value. The valve member may be biased to close the port by a spring. The same spring may also be operative to bias the steam nozzle to its rest position.

The steam wand holder may be a steam wand receiving recess. The compatible steam wand may comprise an elongate tubular body having head at one end in which the steam nozzle coupling is located. The head may have a larger maximum width (diameter) than the body. The head may be part spherical. The compatible steam wand may have a tapered neck region between the head and the body. The steam wand receiving recess may be configured to receive the head of the compatible steam wand and a portion of the steam wand body adjacent the head. The recess may comprise a first portion for receiving the head of the compatible steam wand and a second portion below the first portion for receiving a portion of the steam wand body adjacent the head, the first portion having a larger maximum width (diameter) than the second portion. The first portion of the recess may be part spherical. The second portion may be part cylindirical. The steam wand receiving recess may be defined in a front-end face region of the connector body, the outlet end of the steam nozzle projecting beyond said front end face when the steam nozzle is in its rest position. The first and second portions of the wand receiving recess may comprise contiguous cavities in the connector body. The second portion of the recess may open at a lower face of the connector body. The steam nozzle bore may be aligned generally horizontally and open into the recess at a position opposite to the front-end face of the body.

In an embodiment, the steam wand connector comprises a steam wand insertion member movable between an open position and a closed position, wherein the arrangement is configured such that when the wand insertion member is in the open position the steam wand holder and the outlet end of the steam nozzle are accessible to enable a user to engage the outlet end of the steam nozzle with the steam nozzle coupling of the compatible steam wand and that when in the wand insertion member is in the closed position it is operative to hold the compatible steam wand in the holder against the bias force acting on the steam nozzle. The arrangement may be configured such that, in use when inserting the compatible steam wand into the holder, with the wand insertion member in its open position the outlet end of the steam nozzle is engageable with the steam inlet coupling of the compatible steam wand before the steam wand is fully inserted in the holder, the wand insertion member and the compatible steam wand having corresponding cam surfaces configured such that on subsequent movement of the wand insertion member to the closed position, the wand insertion member is operative to press the compatible steam wand fully into the holder, moving the steam nozzle to its operative position. The corresponding cam surface of the steam wand insertion member may comprise at least one curved cam surface which engages a head of the compatible steam wand. The steam wand may have a part spherical head and the at least one curved cam surface may engage the head.

Where the steam wand holder comprises a steam wand receiving recess and the steam wand has a head for location in the recess, the steam wand insertion member may be operative in use to press the head of the compatible steam wand fully into the recces as it moves to the closed position.

Where the steam wand holder comprises a steam wand receiving recess defined in front-end face region of a connector body, the steam wand insertion member may comprise a front wall which in its closed position locates in front of the front-end wall of the connector body, the corresponding cam surface(s) of the steam wand insertion member being defined by said front wall. Said front wall may define a slot and a pair of said corresponding cam surfaces, one either side of the slot. Where the compatible steam wand comprises a head for location in said wand receiving recess in which the steam nozzle coupling is defined, the steam wand may have a handle attached to the head on the opposite side to the coupling, the arrangement being configured such that the handle projects through the slot when the steam wand insertion member is in its closed position and the wand is fully inserted in the recess.

In accordance with a second aspect of the invention, there is provided a beverage preparation machine for use in the beverage preparation system according to the first aspect as set out above, the beverage preparation machine comprising a steam wand connection arrangement including a steam wand holder for releasably mounting a compatible steam wand to the beverage preparation machine and a source of steam, the connection arrangement including a connector body and a steam nozzle movably mounted in the connector body, the steam nozzle having a steam inlet port, a steam outlet port, and a steam passage connecting the steam inlet port with the steam outlet port, the steam outlet port being located at an outlet end of the steam nozzle, the steam nozzle being movable between an operative position in which the steam inlet port is fluidly connected with the source of steam and a rest position in which the steam inlet port is fluidly isolated from the source of steam, the steam nozzle being biased to the rest position, the arrangement configured such in the rest position of the steam nozzle its outlet end is positioned for engagement with the steam nozzle coupling of a compatible steam wand before the wand is fully inserted in the holder.

The beverage preparation machine according to the second aspect of the invention may have any of the features of the beverage preparation machine which forms part of the beverage preparation system as set out above.

In an embodiment of the beverage preparation machine according to the second aspect of the invention, the steam wand holder comprises a steam wand receiving recess for receiving a head region of a compatible steam wand, the outlet end of the steam nozzle projecting into the recess. The steam wand receiving recess may be defined in a front-end face region of the connector body and the outlet end of the steam nozzle may project beyond said front-end face when the steam nozzle is in its rest position. The steam nozzle may be aligned generally horizontally and may project into the recess from a side opposite to the front-end face of the body.

In accordance with a third aspect of the invention, there is provided a compatible steam wand for use in a beverage preparation system in accordance with the first aspect of the invention as set out above, the steam wand comprising an elongate body having a head at one end, a steam nozzle coupling bore defined in the head for receiving an outlet end portion of the steam nozzle of the beverage preparation machine, the steam wand defining a steam conduit extending through the body to an outlet and which steam conduit is fluidly connected with the steam nozzle coupling bore.

The steam nozzle coupling bore may extend orthogonally to a longitudinal axis of the wand body. The steam nozzle coupling bore may at a side of the head with faces inwardly towards the beverage preparation machine in use. The steam wand may have a handle attached to a head on the opposite side for the steam nozzle coupling bore.

The head may be part spherical.

In accordance with a fourth aspect of the invention, there is provided a method of using the beverage preparation system in accordance with the first aspect of the invention, the method comprising engaging the outlet end of the steam nozzle with the steam nozzle coupling of the compatible steam wand prior to fully inserting the steam wand in the holder, subsequently moving the steam wand so that it is fully inserted in the holder, wherein said subsequent movement of the steam wand so that it is fully inserted in the holder causes the steam nozzle to be moved to its operative position.

In an embodiment, the method comprises only partly engaging the outlet end of the steam nozzle with the steam nozzle coupling of the steam wand prior to fully inserting the steam wand in the holder, wherein said subsequent movement of the steam wand so that it is fully inserted in the holder causes the outlet end of the steam nozzle to become fully engaged in the steam nozzle coupling bore and the steam nozzle to be moved to its operative position.

In an embodiment, the steam wand holder comprises a recess defined in a connector body for receiving the head region of the compatible steam wand, the outlet end of steam nozzle projecting through the recess when the steam nozzle is in its rest position, the method comprising engaging the outlet end with the steam nozzle coupling prior to fully inserting the head of the steam wand in the recess, the step of fully inserting the wand in the holder comprising subsequently moving the steam wand to engage the head fully in the recces.

In an embodiment wherein the beverage preparation machine has a steam wand insertion member, the method comprising engaging the outlet end of the steam nozzle with the steam nozzle coupling of the compatible steam wand prior to fully inserting the steam wand in the holder with the steam wand insertion member in its open position, the step of subsequently moving the steam wand so that it is fully inserted in the holder comprising moving the steam wand insertion member to its closed position such that the corresponding cam surfaces of the steam wand insertion member and the steam wand co-operate to cause the steam wand to become fully engaged in the holder and the steam nozzle to move to its operative position. Where the steam wand holder comprises a steam wand receiving recess and the steam wand has a head for location in the recess, the steam wand insertion member may be operative to press the head of the compatible steam wand fully into the recces as it moves to the closed position.

In an embodiment, the steam nozzle coupling comprises a steam nozzle coupling bore defined in a head of the steam wand, the step of engaging the outlet end of the steam nozzle with the steam wand coupling comprising inserting the outlet end of the steam nozzle in the coupling bore.

In accordance with a further aspect of the invention, there is provided a beverage preparation system including a beverage preparation machine and a compatible steam wand, the beverage preparation machine has a wand holder for releasably mounting the wand and a source of steam, the beverage preparation machine includes a steam nozzle engageable with the wand to introduce steam into the wand from the steam source in use, the nozzle being mounted for movement between an operative position in which it is fluidly connected with the source of steam and a rest position in which it is fluidly isolated from the source of steam and biased to the rest position, the system being configured such that when the nozzle is in its rest it can be at least partially engaged with the wand before the wand is fully inserted in the holder and such that the steam nozzle is moved to the operative position on insertion of the wand fully into the holder.

### DETAILED DESCRIPTION OF THE INVENTION

In order that the invention may be more clearly understood, embodiments thereof will now be described, by way of example only, with reference to the accompanying drawings of which:

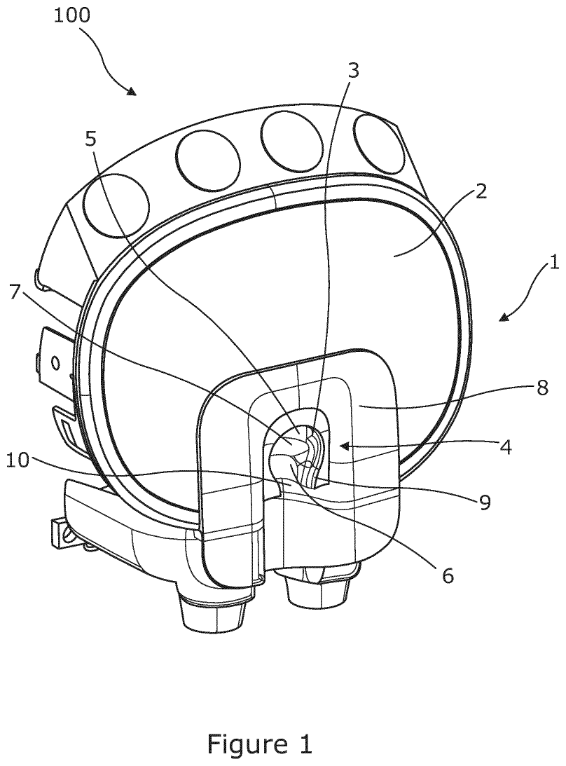

FIG. 1 is a perspective view illustrating a basic steam wand connector arrangement of a beverage preparation machine which can be modified in accordance with an aspect of the invention;

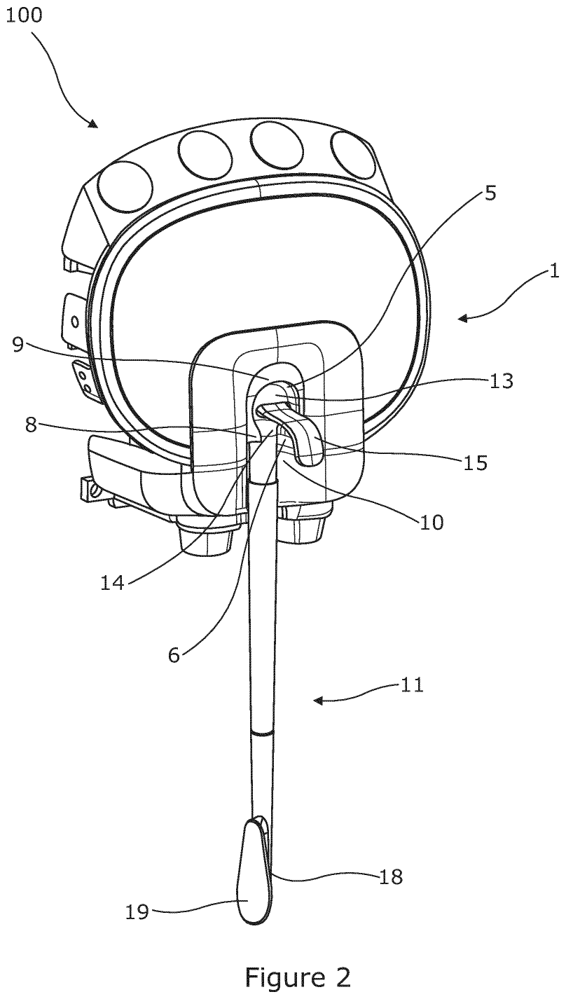

FIG. 2 is a view similar to that of FIG. 1 showing a compatible steam wand mounted in the connector arrangement;

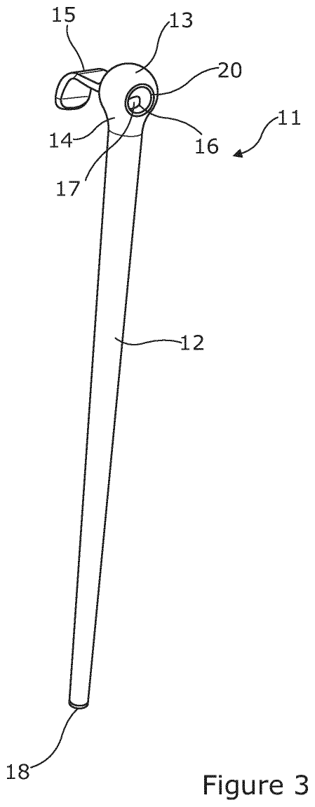

FIG. 3 is a perspective view of a compatible steam wand in accordance with an aspect of the invention;

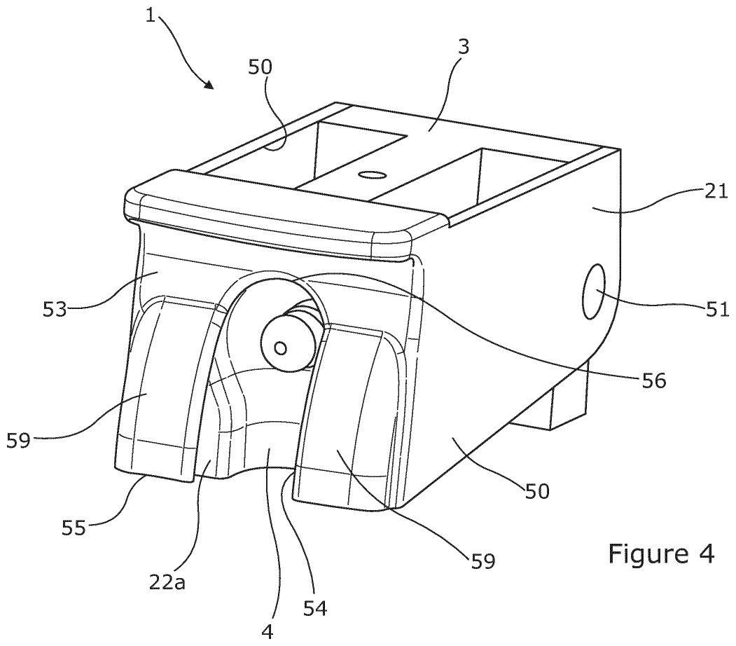

FIG. 4 is a perspective view of part of a steam wand connector forming part of a steam wand connector arrangement for a beverage preparation machine in accordance with an aspect of the invention, showing a steam wand insertion member of the connector in a closed position;

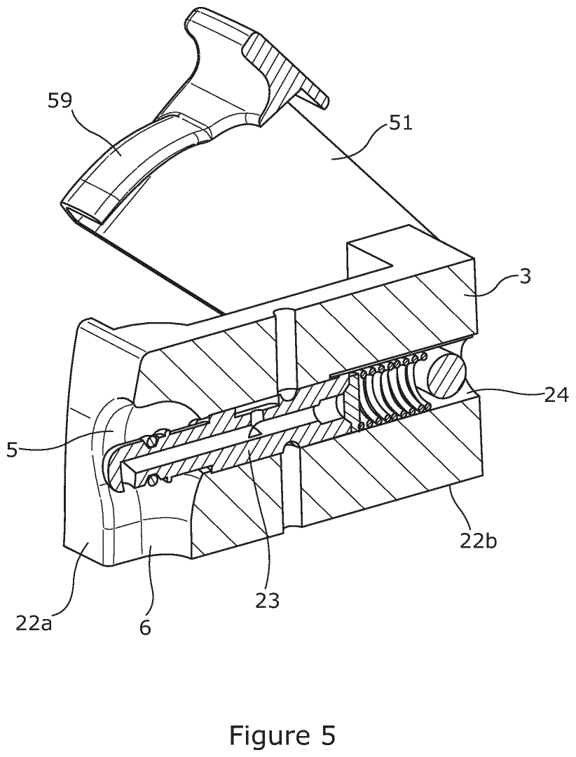

FIG. 5 is a perspective cross sectional view through the connector of FIG. 4, showing the steam wand insertion member in an open position;

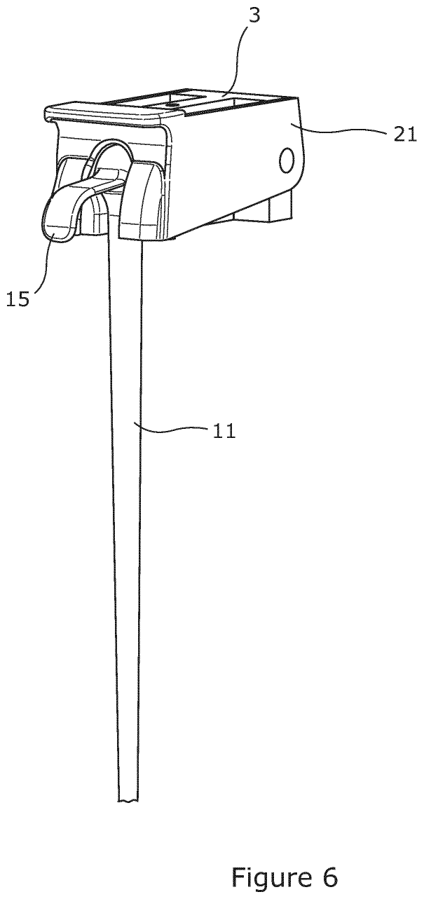

FIG. 6 is a perspective view of the connector of FIGS. 4 and 5 showing a compatible steam wand mounted in the connector and the steam wand insertion member in a closed position;

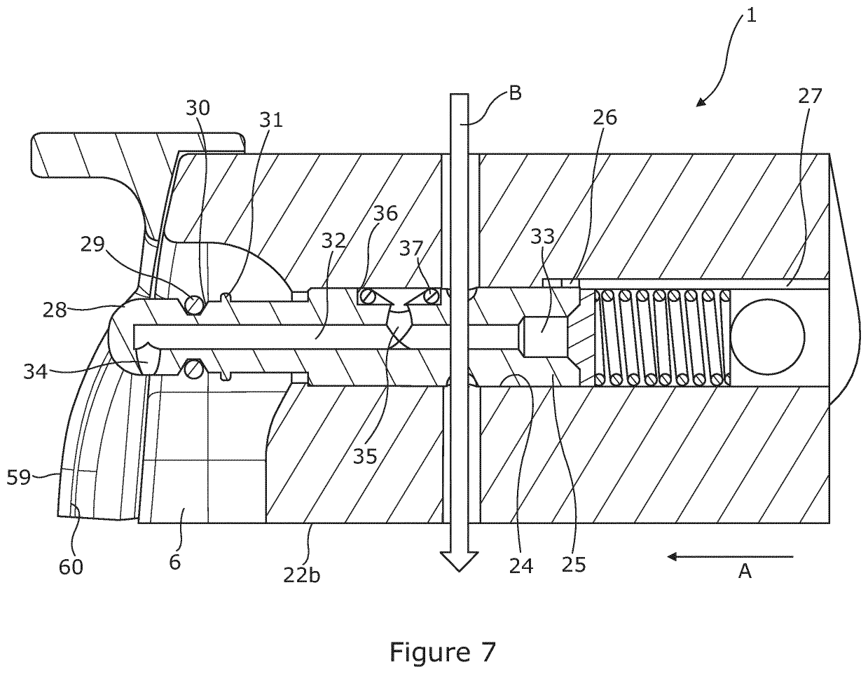

FIG. 7 is a part-schematic cross-sectional view through the steam wand connector of FIG. 4, showing the steam wand insertion member is a closed position and a steam nozzle in a rest position; and

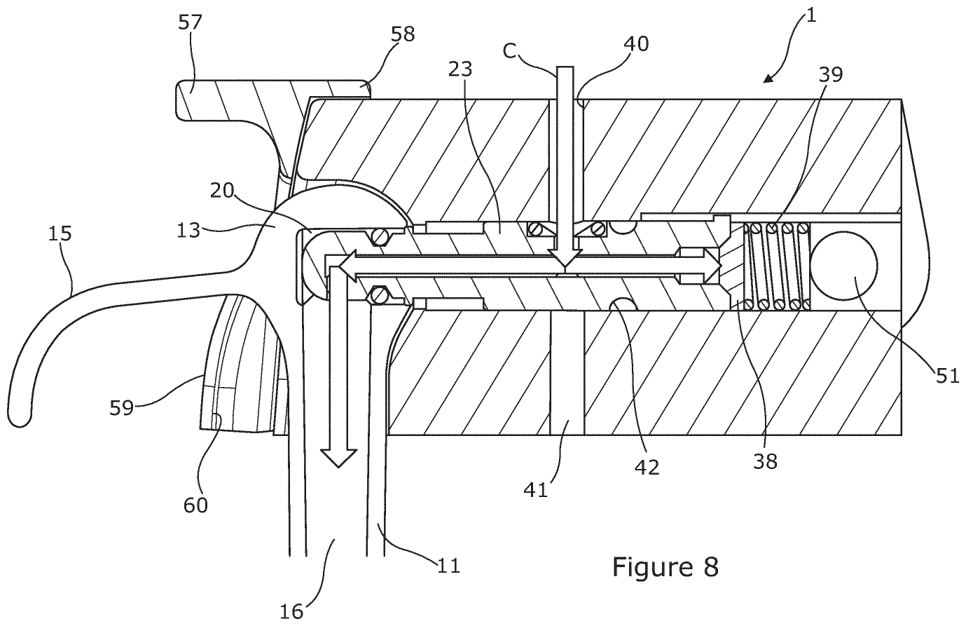

FIG. 8 is a view similar to that of FIG. 7 but showing the connector with the steam wand of FIG. 3 mounted to the connector and illustrating an operative position of the steam nozzle.

Referring to the Figures, like numbers represent like components.

Referring firstly to FIGS. 1 and 2, these illustrate a basic steam wand connection arrangement 1 in a beverage preparation machine 100 which can be adapted in accordance with the present invention.

The steam wand connector arrangement 1 is set into to a beverage preparation machine faceplate 2. For simplicity's sake the remainder of the beverage preparation machine is not shown, but may be, for example, a coffee preparation machine.

The steam wand connector arrangement 1 comprises a steam wand connector body 3 which defines a steam wand receiving recess 4 that is open at a front-end face of the connector body. The recess has a first upper portion 5 and a second lower portion 6, the upper and lower portions being adjacent to and contiguous with each other. The upper portion 5 of the recess 4 has a greater maximum width (diameter) than the lower portion 6. The upper portion 5 of the recess defines a concave curve 7 as it tapers towards the lower portion 6. The upper portion 5 of the recess may be a part spherical cavity with the lower portion 6 being a part cylindrical shaped cavity. Both portions of the recess are open at the front-end face of the body 3. The lower portion 6 of the recess also opens at a lower face of the body to form a restricted opening or neck below the upper portion 5.

A steam wand connector plate 8 is mounted within faceplate 2 in front of the connector body 3 and has an aperture 9 aligned with and corresponding in shape to the recess 4 in the connector body 3. The aperture 9 defines an entrance slot to the recess 4. The connector plate 8 is curved inwardly to define a channel 10 below the recess 4 in the connector body 3.

A compatible steam wand 11 for use with the connector 1 can be seen best in FIG. 3. The steam wand 11 has an elongate tubular body 12 and a part spherical head 13 at one end, which end is uppermost in use. The head 13 has a larger maximum width (diameter) than the body 12. The wand merges between the head 13 and the body 12 to define a neck region 14. A handle 15 is attached to a front side of the head 13. However, the handle could be attached to body or to any suitable part of the wand. In alternative embodiments, the handle 15 could be omitted.

The steam wand 11 defines a steam conduit 16 which extends longitudinally through the body 12 and part of the head 13 from an inlet 17 to an outlet 18 at or close to the end of the body 12 distal from the head 13. In use, the distal or outlet end 18 is a lowermost end and is inserted into a beverage container so that steam can be introduced into a beverage held in the container by passing the steam through the conduit 16 and the outlet. The steam outlet 18 may comprise one or more nozzles at the outlet end. As illustrated in FIG. 2, the steam wand 11 can be provided with alternative outlet arrangements and could be provided with a steam deflector 19 which can also be used to stir a beverage after steaming. A steam nozzle coupling 20 in the form of a substantially cylindrical blind bore is defined in the head extending orthogonally to the longitudinal axis of the wand body and the conduit 16. The steam nozzle coupling bore 20 opens at a rear side of the head 13 opposite the handle and intersects the steam conduit 16, which opens into the steam nozzle coupling bore at its inlet end.

In some embodiments, the wand body 12 is integrally attached to the wand head 13. Alternatively, the body 12 can be removably attached to the wand head 13.

The steam wand head 13, the body 12, and the handle 15 can be made from materials such as metal, alloy, polymer substrates such as for instance polyethylene terephthalate (PET), polylactic acid (PLA), polyamide (PA), polycarbonate (PC), rubber, silicone and/or any combination thereof

The steam wand head 13 and the steam wand body 12 are obtained through conventional manufacturing processes, such as moulding (for example 2-stage moulding and/or over-moulding), casting, extrusion. The body 12 of the steam wand and the conduit 16 extending through the body may both be tapered, getting smaller towards the outlet end, for ease of moulding.

As shown in FIG. 2, the steam wand 11 is mounted to the beverage preparation machine by inserting the head 13 of the wand in the larger upper portion 5 of the recess 4, with the body 12 of the wand extending downwardly through the narrower lower portion 6 of the recess 4 and the channel 10 defined by the connector plate 8 below the recess. When the steam wand 11 is inserted correctly into the recess 4, a lower region of the part spherical head 16 rests on the concave curved region 7 of the recess, which forms a seat for supporting the head 13 from below. The shape and dimensions of the recess 4 generally correspond to the shape and dimensions of the head 13 and a region of the body 12 proximal to the head, with the head and body region of the wand being slightly smaller to enable them to be inserted into the recess whilst the wand is held securely in a desired orientation once fully mounted in the recess.

The curved shape of the steam wand head 13 and the correspondingly curved shape of the upper portion 5 of the recess, especially the neck region 7, is advantageous as it enables the head 13 to be inserted in multiple positions/orientations, and then rotated easily to align the body 12 with the channel-shaped second portion 6 of the recess 4 for easy orientation and insertion. This enables a user to insert the wand 11 without carefully initially aligning the wand with the connector plate 2. It will be appreciated that the recess 4 and head 13 can have alternative shapes which achieve the same effect.

FIGS. 4 to 8 illustrate how the connector arrangement of FIGS. 1 to 3 can be modified in accordance with an aspect of the present invention to provide a mechanism for manually connecting the wand with a source of steam in the beverage preparation machine when the steam wand 11 is mounted in the connector arrangement. Like reference numerals will be used to denote like parts.

The modified connector arrangement 1, includes a connector body 3 and a wand insertion member 21 pivotably connected to the connector body 3. The connector body 3 is similar to the connector body 3 described above and is mounted in a beverage preparation machine in a similar position so that a front-end face 22a of the connector body is located at the front of the machine, typically within a faceplate 2, and is accessible to a user. A wand receiving recess 4 is defined in a front-end region of the connector body 3 and opens at the front-end face 22a of the connector body.

The wand receiving recess 4 is profiled to receive the compatible steam wand 11 as illustrated in FIG. 3 and has a shape which corresponds broadly to that of the recess 4 as described above, having a larger width (diameter) upper portion 5 for receiving the head 13 of the compatible wand 11. The upper portion 5 of the recess tapers into a second, lower portion 6 having a smaller maximum width (diameter) than the upper portion. The lower portion 6 of the recess forms a narrower, neck region of the recess 4 for receiving a region of the body 12 of the wand adjacent the head. The upper portion 5 of the recess may be a part spherical cavity with the lower portion 6 being a part cylindrical shaped cavity. The recess 4 is open at the front-end face 22a of the connector body and the lower portion 6 of the recess is also open at a lower face 22b of the connector body.

The modified connector arrangement 1 includes a steam nozzle 23 which manually engages in the steam nozzle coupling bore 20 of the compatible steam wand. The connector body 3 defines a cylindrical nozzle bore 24 which opens into the upper portion 5 of the wand receiving recess from the rear. In use, the bore 24 is aligned generally orthogonal to the longitudinal extent of the compatible steam wand 11 when mounted in the recess 4. Typically, the bore 24 is aligned to extend generally horizontally when the beverage preparation system is in use.

The steam nozzle 23 is slidably mounted in the bore 24. The steam nozzle 23 has an elongate main body 25. At least some regions of the main body 25 are cylindrical and a close sliding fit within the bore 24. The man body 25 of the steam nozzle 23 and the connector body 3 have corresponding features which prevent the nozzle 23 from rotating within the bore 24 whilst permitting the nozzle 23 to slide axially along the bore 24 between a rest position as shown in FIG. 7 and an operative position as shown in FIG. 8. In an embodiment, the corresponding features include at least one spline 26 on the nozzle main body which engages in a corresponding groove 27 in the connector body 3. However, other suitable arrangements for preventing the steam nozzle form rotating in the bore can be used.

The steam nozzle has an outlet end 28 which projects into the upper portion 5 of the recess 4 in the connection body. Indeed, when the steam nozzle 23 is in the rest position, the outlet end 28 extends beyond the front-end face 22a of the connector body. The outlet end 28 of the steam nozzle 23 is generally cylindrical and is dimensioned to be a close sliding fit in the steam nozzle coupling bore 20 of the compatible steam wand 11. A seal 29 is located in a groove 30 about the outer surface of the outlet end for engagement with an inner surface of the steam nozzle coupling bore 20 to provide a seal to prevent steam from escaping between the steam nozzle and wand in use.

Alternatively, a seal may be provided in the steam nozzle coupling bore 20 in the steam wand 11. A circumferential ridge 31 projects outwardly about the outer surface of outlet end of the main body 25 inboard of the seal 29. The ridge 31 engages with the steam wand when the outlet end of the nozzle is correctly inserted in the steam wand.

A nozzle steam conduit or passage 32 extends longitudinally through the main body of the steam nozzle. The steam conduit 32 is closed axially at the outlet end but is open axially at the opposite end of the main body to form an over pressure port 33. A steam outlet port 34 fluidly connected with the steam conduit 32 extends through a wall of the main body at the outlet end 28 orthogonally to the longitudinal axis of the steam conduit 32. The outlet port 34 is arranged to face downwardly in use and is positioned in line with the steam conduit inlet 17 in the steam wand 11 when the outlet end of the steam nozzle 23 is correctly inserted in the steam nozzle coupling bore 20. A steam nozzle inlet port 35 into the steam conduit 32 extends through a wall of the main body orthogonally to the longitudinal axis of the conduit at a position part way along its length. The steam nozzle inlet port 35 opens into a circular recess 36 formed in the outer surface of the main body. The recess 36 houses a circular seal 37 which extends about the inlet port 35 and engages with an inner surface of the nozzle bore 24 in the connector body to form a seal between the inlet port and the bore.

An over pressure valve member 38 is held in engagement with the inner axial end of the steam nozzle main body 25 by a compression spring 39 and is operative to close the over pressure port in normal use. However, should the pressure inside the steam conduit 32 of the steam nozzle exceed a predetermined value sufficient to overcome the bias force of the spring 39, the valve member 38 is lifted off its seat away from the main body to allow excess pressure to vent into the nozzle bore 24. The spring 39 is also operative to bias the steam nozzle 23 to the rest position as shown in FIG. 7. The steam nozzle 23 can be moved axially from the rest position to the operative position shown in FIG. 8 against the bias force of the spring 29. Engagement of the spline 26 with an end of the groove 27 prevents the steam nozzle 23 from moving axially outwardly, in the direction of arrow A, beyond the rest position.

A steam inlet duct 40 extends through the connector body 3 and opens into the nozzle bore 24. The steam inlet duct 40 is fluidly connected with a source of steam (not shown) in the beverage preparation machine. A steam venting duct 41 is also defined through the connector body 3 and opens into the nozzle bore at a position opposite the steam inlet duct 40. The steam venting duct 41 is fluidly connected with a suitable dump to which steam can be safely directed, which may be a water reservoir, or it may be connected with atmosphere at a safe location where the steam will not impinge on a user. A circumferential steam vent groove 42 is provided about the outer surface of the main body of the steam nozzle inboard of the steam inlet port at a position which aligns with the steam inlet and steam vent ducts 41, 42 when the steam nozzle 23 is in its rest position. This allows any steam that may be inadvertently passed through the steam inlet duct 40 when the steam nozzle 23 is in the rest position to pass through the groove inside the nozzle bore 24 from the steam inlet duct 40 to the steam vent duct 41 to be safely vented, as indicated by arrow B in FIG. 7.

When the steam nozzle 23 is in its operative position, the steam inlet port 35 is aligned with the steam inlet duct 40. In this position, steam from the steam source in the beverage preparation machine can be introduced into the steam conduit 32 in the nozzle through the steam inlet duct 40 and the steam inlet port 35 as indicated by arrows C in FIG. 8. The steam inlet port seal 37 engages between the surface of the nozzle bore 24 and the outer surface of the main body of the nozzle about the inlet port 35 and the inlet duct 40 to prevent steam escaping between the connector block and the steam nozzle.

The wand insertion member 21has parallel, opposed side walls 50 which locate adjacent respective sides of the connector body and which are pivotally connected to the connector body 3 by a pivot pin 51 towards an inner end. In this embodiment, the pivot pin 51 extends through the nozzle bore 24 and acts as an abutment member against which the nozzle spring 39 reacts to bias the nozzle. However, it will be appreciated that other arrangements can be made to provide a fixed abutment on the connector body for the spring 39 and to pivotally connect the wand insertion member 21 to the connector body. The side walls 50 are interconnected at a front end by a front wall 53.

The wand insertion member 21 is pivotably movable relative to the connector body 3 between a raised, open position as shown in FIG. 5 and a lowered, closed position as shown in FIGS. 4, and 6 to 8. When the wand insertion member is in its closed position, the front wall 53 locates in front of the front-end face 22a of the connector body. In the open position, the front wall 53 is located above the connector body allowing free access to the wand receiving recess 4 and the steam nozzle 23.

An inverted generally U-shaped slot 54 is provided in the middle of the front wall. The slot 54 is open at a lower end 55 of the front wall and is closed at an upper end 56. A grip 57 projects outwardly along the upper edge 55 of the front wall 53 and can be grasped by a user to move the steam wand insertion member 21 between its open and closed positions. A lip 58 projects inwardly along an upper edge of the front wall 53 for engagement with an upper surface of the connector body 3 to limit downward movement of the steam wand insertion member.

The slot 54 is dimensioned so that the handle 15 of the compatible steam wand 11 is able to project outwardly through the slot. Either side of the slot 54, the front wall 53 has cam regions 59 which are curved outwardly. The cam regions 59 are configured to locate about the head 13 of the steam wand either side of the handle. The inner surfaces of the cam regions define cam surfaces 60 which are operative to engage the head region 13 of the wand either side of the handle and to gradually press the steam wand head into the recess 4 in the connector body as the steam wand insertion member is moved from the raised open position towards the lowered, closed position. The degree of curvature of the cam regions 59 increases along their length from the lower end 55 of the front wall towards the upper end. As a consequence, the spacing between the inner cam surface 60 of each of the cam regions and the front-end face 22a of the connector block 3 is less at the upper end of the cam regions than at the lower end of the cam regions when the steam wand insertion member is closed. The arrangement is configured so that the inner surfaces 60 of the cam regions proximal their upper ends are in engagement with the head 13 of the steam wand when the stream wand insertion member 21 is in its closed position and a steam wand 11 located in the recess 4.

Operation of the modified connector arrangement 1 will now be described.

With the steam wand insertion member 21 in its closed position and no steam wand 11 engaged in the steam wand receiving recess 4, the steam nozzle 23 is biased to its rest position as shown in FIG. 7. In the rest position, the outlet end 28 of the steam nozzle 23 projects into the upper portion 5 of the steam wand receiving recess beyond the front-end face 22a of the connector body 3. The steam nozzle inlet port 25 is fluidly isolated from the steam inlet duct 40 in the connector body and the steam inlet and vent ducts 40, 41 are fluidly connected through the nozzle bore 24 by the vent groove 42. In this configuration, no steam can be introduced into the steam nozzle 23 through the steam inlet duct 40 and any steam that is inadvertently passed through the steam inlet duct 40 is safely vented via the vent duct 41. Typically, the beverage preparation machine will have an additional valve or other control arrangement arranged so that steam is only provided to the steam inlet duct 40 when a steam wand 11 has been correctly mounted, the steam nozzle is in its operative position and a steaming process has been requested by a user. However, the nozzle arrangement of the present embodiment provides an additional safety feature to ensure that steam is not emitted from nozzle 23 without a steam wand in position.

When a user wishes to use the steaming wand 11 to froth a beverage, they raise the steam wand insertion member 21 using the grip 47 to allow access to the wand receiving recess 4 and the steam nozzle 23. Holding the steam wand 11 by the handle 15, the user positions the outlet end of the wand in a beverage container holding the beverage to be frothed positioned below the recess 4 and moves the head 13 of the wand to locate the outlet end 28 of the nozzle 23 in the steam nozzle coupling bore 20. The steam nozzle is a relatively close fit within the coupling bore, especially once the nozzle seal 29 engages inside the bore. However, the force required to insert the outlet end 28 of the nozzle into the coupling bore 20 is lower than the bias force of the nozzle spring 39 so that the wand can be pressed onto the nozzle 23 to engage the outlet end 28 of the nozzle 23 in the coupling bore 20 fully without moving nozzle 23 to the operative position. Initially the user may only partially engage the outlet end 28 of the nozzle in the coupling bore 20. The user also aligns the head 13 of the wand with the upper portion 5 of the recess 4 and the neck region 14 of the wand body 12 with lower portion 6 of the recess and partially engages the head 13 and neck 14 of the wand in the recess but without moving the nozzle significantly from its rest position. Engagement of the nozzle in the coupling bore 20 will help to correctly align the head 13 of the wand and as discussed previously, the curved shape of the head 13 and the correspondingly curved shape of the upper portion 5 of the recess enables to user to manipulate the wand to align the neck region 14 of the wand with the lower portion 6 of the recess. Once the nozzle 23 has been at least partly engaged in the coupling bore 20 and the wand is correctly aligned with the recess 4 and perhaps partly engaged in the recess, the user holds the wand handle 15 in one hand and uses the other to lower the steam wand insertion member 21. As the steam wand insertion member is lowered, the cam regions 59 engage the head 13 on the wand either side of the handle and due to the shape of their inner cam surfaces 60, gradually press the head 13 and neck region 14 into the recess 4. Initially, if the user has not already fully engaged the nozzle in the coupling bore 20, the steam wand insertion member will press the head 13 fully on to the outlet region 28 of the steam nozzle until the head engages the ridge 31. Thereafter, continued lowering of the steam wand insertion member 21 will cause it to press the steam wand head 13 and neck region 14 fully into the recess 4, moving the nozzle 23 to its operative position. Once the steam wand insertion member 21 is fully lowered, the steam wand 11 will be coupled with the steam nozzle 23 and correctly located in the steam wand receiving recess 4 as illustrated in FIG. 8. The steam wand insertion member 21 has a slight over-centre action so that once fully lowered to its closed position, the force of the nozzle spring 39 acting on the wand through the nozzle is not able to move the steam wand insertion member 21 towards its open position and the steam wand 11 is firmly clamped between the nozzle 23 and the steam wand insertion member 21. With the steam nozzle in its operative position, the nozzle steam inlet port 35 is aligned with the steam inlet duct 40 in the connector body, so that steam can be directed from the inlet duct 40 into the wand through the steam nozzle. The user can now select a steaming operation. On completion of the steaming operation, the user is able to remove the steam wand 11 by reversing the above steps. On lifting the steam wand insertion member 21, the nozzle spring 39 will bias the nozzle 23 towards its rest position, moving the wand at least partially out of the recess 4 and fluidly disconnecting the nozzle steam conduit 32 from the steam inlet duct 40. The arrangement is typically configured such that the steam wand 11 is not fully ejected from the recess 4 on opening of the steam wand insertion member 21 and remains engaged on the outlet end 28 of the steam nozzle so that the user can safely remove the steam wand 11.

The steam wand insertion member 21 provides a mechanical advantage assisting the user to insert the wand in the recess 4 and move the steam nozzle to the operative position. The arrangement can be configured such that the force required to move the nozzle to the operative position is relatively high and so not easily done without using the steam wand insertion member 21 and with a wand correctly coupled with the nozzle. The control system of the beverage preparation machine may be configured to prevent the steam wand insertion member 21 being moved from its closed position whilst a steaming operation is in process or to stop a steaming process in the event movement of the steam wand insertion member is detected. The control system may also be configured such that a steaming operation will only be initiated if the steam nozzle 23 is in its operative position and/or the steam wand insertion member 21 is closed and/or a steam wand 11 is correctly mounted. Those skilled in the art will be able to configure suitable sensor and locking mechanisms to achieve these effects.

The steam wand insertion member also acts as a shield to protect the user from any steam than may be emitted from the steam nozzle or leak from between the nozzle and the wand. The steam wand insertion member 21 allows mounting of the steam wand to be completed and its release to be initiated without the user having the touch the wand other than by its handle 15.

The connector body 3 in this embodiment acts as a valve body and the nozzle 23 as a valve member. Whilst it is convenient to provide the steam wand receiving recess 4 and to mount the nozzle 23 in a single integral body 3 this is not essential. The recess could be provided in a separate component from that which mounts the nozzle 23. It will also be appreciated that there are numerous ways in which the hydraulic circuit for the steam nozzle 23 could be configured so that the steam conduit 32 in the nozzle is isolated from the steam source when in a rest position and connected to the steam source in an operative position. Furthermore, it is not essential the steam wand receiving recess 4 and the steam wand head 13 be configured so that the steam wand head 13 is pivotable in the upper portion 5 of the recess to align the body 13 of the wand with the lower, narrower portion 6 of the recess.

The steam wand connection arrangement 1 as described above provides a simple and user-friendly arrangement for removably mounting a steam wand 11 to a beverage preparation machine and connecting the steam wand to a source of steam in the beverage preparation machine. It eliminates the need for expensive and complicated actuation arrangements for moving a steam nozzle in the beverage machine to engage with a steam wand after insertion of the wand.

The embodiments are described above by way of example only. Many variations are possible without departing from the scope of protection afforded by the appended claims. For example, the shapes of the wand head 13 and the recess 4 in the connector body can be varied. Indeed, it is not essential that the steam wand 11 be mounted to the beverage machine by engaging a head of the wand in a correspondingly shaped recess. Rather, the steam wand can be mounted in any suitable steam wand holder in a beverage machine provided that in mounting of the wand, it is manually coupled with a steam nozzle and the steam nozzle is moved from an inoperative position in which a steam conduit of the nozzle is fluidly disconnected from a steam source to an operative position in which the conduit is fluidly connected with the steam source. It will also be appreciated that the design of the nozzle and the way in which the steam path through the nozzle is coupled and de-coupled with a steam source can be varied from that disclosed above.

1. A beverage preparation system comprising a beverage preparation machine and a compatible steam wand, the beverage preparation machine comprising a steam wand connection arrangement including a steam wand holder for releasably mounting the compatible steam wand to the beverage preparation machine and a source of steam, the connection arrangement including a connector body and a steam nozzle movably mounted in the connector body, the steam nozzle having a steam inlet port, a steam outlet port, and a steam passage connecting the steam inlet port with the steam outlet port, the steam outlet port being located at an outlet end of the steam nozzle which is engageable with a steam nozzle coupling of the compatible steam wand, the steam nozzle being movable between an operative position in which the steam inlet port is fluidly connected with the source of steam and a rest position in which the steam inlet port is fluidly isolated from the source of steam, the steam nozzle being biased to the rest position, the arrangement configured such in the rest position of the steam nozzle its outlet end is positioned for engagement with the steam nozzle coupling of the compatible steam wand before the wand is fully inserted in the holder and such that the steam nozzle is movable from the rest position to the operative position against the bias force on insertion of the compatible steam wand fully into the holder with the outlet end of the steam nozzle engaged with the steam nozzle coupling of the compatible steam wand.

2. A beverage preparation system as claimed in claim 1, wherein the connector body defines a bore in which the steam nozzle is slidably located and a steam inlet duct connected with the source of steam which opens into the bore, the inlet port of the steam nozzle being fluidly coupled with the steam inlet duct when the steam nozzle is in the operative position and fluidly isolated from the steam inlet duct when the steam nozzle is in its rest position.

3. A beverage preparation system as claimed in claim 2, the connector body further defining a venting duct which opens into the nozzle bore, the arrangement being configured such that when the steam nozzle is in its rest position, a fluid path is defined between the steam inlet duct and the venting duct.

4. A beverage preparation system as claimed in claim 1, wherein the steam wand holder comprises a steam wand receiving recess.

5. A beverage preparation system as claimed in claim 4, wherein the steam wand receiving recess is defined in a front-end face region of the connector body which is accessible to a user, the outlet end of the steam nozzle projecting beyond said front end face when the steam nozzle is in its rest position.

6. A beverage preparation system as claimed in claim 5, wherein the connector body defines a bore in which the steam nozzle is slidably located and a steam inlet duct connected with the source of steam which opens into the bore, the inlet port of the steam nozzle being fluidly coupled with the steam inlet duct when the steam nozzle is in the operative position and fluidly isolated from the steam inlet duct when the steam nozzle is in its rest position, and wherein the bore is aligned generally horizontally and opens into the steam wand receiving recess at a position opposite to the front-end face of the body.

7. A beverage preparation system as claimed in claim 1, wherein the compatible steam wand comprises an elongate tubular member having a head portion at one end in which the steam nozzle coupling is located.

8. A beverage preparation system as claimed in claim 1, wherein the steam wand connector comprises a steam wand insertion member movable between an open position and a closed position, wherein the arrangement is configured such that when the wand insertion member is in the open position the steam wand holder and the outlet end of the steam nozzle are accessible to enable a user to engage the outlet end of the steam nozzle with the steam nozzle coupling of the compatible steam wand and that when in the wand insertion member is in the closed position it is operative to hold the compatible steam wand in the holder against the bias force acting on the steam nozzle.

9. A beverage preparation system as claimed in claim 8, wherein the arrangement is configured such that, in use when inserting the compatible steam wand into the holder, with the wand insertion member in its open position the outlet end of the steam nozzle is engageable with the steam inlet coupling of the compatible steam wand before the steam wand is fully inserted in the holder, the wand insertion member and the compatible steam wand having corresponding cam surfaces configured such that on subsequent movement of the wand insertion member to the closed position, the wand insertion member is operative to press the compatible steam wand fully into the holder, moving the steam nozzle to its operative position.

10. A beverage preparation system as claimed in claim 8, wherein the steam wand holder comprises a steam wand receiving recess and wherein the compatible steam wand comprises an elongate tubular member having a head portion at one end in which the steam nozzle coupling is located, the steam wand insertion member being operative in use to press the head portion of the compatible steam wand fully into the steam wand receiving recces as it moves to the closed position.

11. A beverage preparation machine for use in the beverage preparation system of claims 1, the beverage preparation machine comprising a steam wand connection arrangement including a steam wand holder for releasably mounting a compatible steam wand to the beverage preparation machine and a source of steam, the connection arrangement including a connector body and a steam nozzle movably mounted in the connector body, the steam nozzle having a steam inlet port, a steam outlet port, and a steam passage connecting the steam inlet port with the steam outlet port, the steam outlet port being located at an outlet end of the steam nozzle, the steam nozzle being movable between an operative position in which the steam inlet port is fluidly connected with the source of steam and a rest position in which the steam inlet port is fluidly isolated from the source of steam, the steam nozzle being biased to the rest position, the arrangement configured such in the rest position of the steam nozzle its outlet end is positioned for engagement with the steam nozzle coupling of a compatible steam wand before the wand is fully inserted in the holder.

12. A beverage preparation machine as claimed in claim 11, wherein the steam wand holder comprises a steam wand receiving recess for receiving a head region of a compatible steam wand, the outlet end of the steam nozzle projecting into the recess.

13. A beverage preparation machine as claimed in claim 12, wherein the steam wand receiving recess is defined in a front-end face region of the connector body, the outlet end of the steam nozzle projecting beyond said front end face when the steam nozzle is in its rest position.

14. A steam wand for use in a beverage preparation system as claimed in claim 1, the steam wand comprising an elongate body having a head at one end, a steam nozzle coupling bore defined in the head for receiving an outlet end portion of the steam nozzle of the beverage preparation machine, the steam wand defining a steam conduit extending through the body to an outlet and which steam conduit is fluidly connected with the steam nozzle coupling bore.

15. A steam wand as claimed in claim 14 wherein the steam nozzle coupling bore extends orthogonally to a longitudinal axis of the wand body.

16. A steam wand as claimed in claim 15, wherein the steam nozzle coupling bore opens at a side of the head with faces inwardly towards the beverage preparation machine in use.

17. A method of using the beverage preparation system as claimed in claim 1, the method comprising engaging the outlet end of the steam nozzle with the steam nozzle coupling of the compatible steam wand prior to fully inserting the steam wand in the holder, subsequently moving the steam wand so that it is fully inserted in the holder, wherein said subsequent movement of the steam wand so that it is fully inserted in the holder causes the steam nozzle to be moved to its operative position.

18. A method as claimed in claim 17, wherein the method comprises only partly engaging the outlet end of the steam nozzle with the steam nozzle coupling of the steam wand prior to fully inserting the steam wand in the holder, wherein said subsequent movement of the steam wand so that it is fully inserted in the holder causes the outlet end of the steam nozzle to become fully engaged with the steam nozzle coupling and the steam nozzle to be moved to its operative position.

19. A method as claimed in claim 17, wherein the steam wand holder comprises a recess defined in a connector body for receiving a head region of the compatible steam wand, the outlet end of steam nozzle projecting through the recess when the steam nozzle is in its rest position, the method comprising engaging the outlet end with the steam nozzle coupling prior to fully inserting the head of the steam wand in the recess, the step of fully inserting the wand in the recess holder comprising subsequently moving the steam wand to engage the head fully in the recces.

20. A method of using the beverage preparation system as claimed in claim 9, the method comprising engaging the outlet end of the steam nozzle with the steam nozzle coupling of the compatible steam wand prior to fully inserting the steam wand in the holder, subsequently moving the steam wand so that it is fully inserted in the holder, wherein said subsequent movement of the steam wand so that it is fully inserted in the holder causes the steam nozzle to be moved to its operative position; and
the method further comprising engaging the outlet end of the steam nozzle with the steam nozzle coupling of the compatible steam wand prior to fully inserting the steam wand in the holder with the steam wand insertion member in its open position, the step of subsequently moving the steam wand so that it is fully inserted in the holder comprising moving the steam wand insertion member to its closed position such that the corresponding cam surfaces of the steam wand insertion member and the steam wand co-operate to cause the steam wand to become fully engaged in the holder and the steam nozzle to move to its operative position.
